(19) United States
(12) Patent Application Publication
(10) Pub. No.: US 2011/0014315 A1
(43) Pub. Date: Jan. 20, 2011

(54) In-mold decoration of composites manufactured by resin infusion between double flexible tooling system

(75) Inventors: Okenwa O.I. Okoli, Tallahassee, FL (US); Carlos A. Puentes, Tallahassee, FL (US)

Correspondence Address: SUTHERLAND ASBILL & BRENNAN LLP, 999 PEACHTREE STREET, N.E., ATLANTA, GA, 30309, US

(73) Assignee: FLORIDA STATE UNIVERSITY RESEARCH FOUNDATION, INC., Tallahassee, FL (US)

(21) Appl. No.: 12/888,890

(22) Filed: Sep. 23, 2010

Related U.S. Application Data
(62) Division of application No. 12/156,943, filed on Jun. 4, 2008.
Application No. 12/156,943 is a continuation-in-part of application No. 11/789,805, filed on Apr. 25, 2007.
(60) Provisional application No. 60/932,901, filed on Jun. 4, 2007.
(60) Provisional application No. 60/794,576, filed on Apr. 25, 2006.

(51) Int. Cl. B29C 45/57

(52) U.S. Cl. 425/405.1; 425/129.1

(57) ABSTRACT

A resin infusion system uses a housing that has an upper flexible diaphragm and a lower flexible diaphragm such that the two diaphragms form a cavity. A fiber reinforcement mat is positioned within the cavity as is an optional paint film. A mold is positioned below the lower diaphragm. A flow plate has a series of V-shaped grooves is positioned either underneath the lower diaphragm or overtop the upper diaphragm so that the grooves press into the respective diaphragm. A vacuum is created within the cavity causing resin to be drawn into the cavity with the resin interacting with the grooves increasing the turbulence of the resin flow. Once the reinforcement mat is properly wetted, a vacuum is created within the housing, the temperature is increased within the housing, the mold is pressed into the lower diaphragm while a vacuum is created within the housing.

This application claims the benefit of provisional patent application No. 60/932,901 filed on Jun. 4, 2007, which provisional application is incorporated herein by reference, and is a Continuation-in-Part of utility patent application Ser. No. 11/789,805, filed on Apr. 25, 2007, which claims the benefit of provisional patent application 60/794,576 filed on Apr. 25, 2006, all incorporated herein by reference.

### BACKGROUND OF THE INVENTION

1. Field of the Invention

The present invention relates to the use of thermo-formable materials for in-mold decoration of composites that are manufactured by the resin infusion between double flexible tooling system.

2. Background of the Prior Art

Fiber reinforced composite materials are an important class of engineering materials that offer outstanding mechanical properties and unique design flexibility. Such materials are lightweight, corrosive resistant, impact resistant, and exhibit excellent fatigue strength. Composite materials are used in a wide variety of applications including automotive parts, aviation, marine vessels, offshore structures, containers and piping, and sporting goods among many others. Liquid composite molding, which includes resin transfer molding, reaction injection molding, and resin infusion, is one of the most attractive manufacturing solutions for producing high quality, affordable, and environmentally friendly composite materials.

Recently, a considerable amount of progress has been achieved in liquid composite molding techniques such as constituent material development, tooling, reinforcement preform development, curing control, and process simulation. These advances have lifted the liquid composite molding process to new heights.

One major hurdle that continues to receive considerable attention concerns the costs of liquid composite molding. In most techniques, the part being made is formed between an upper mold and a lower mold. Each of these molds is very costly and the molds are very time consuming to produce. Additionally, as the resin contacts the surface of the molds, each mold must be cleaned and prepared between cycles. Furthermore, the resin flows into the cavity between the molds in three dimensions. This three dimensional resin flow makes flow control complicated and increases the potential for end product defects due to dry spots. As defective parts cannot be repaired, they must be discarded adding to the overall manufacturing costs of the products being produced.

To address the need for a liquid composite molding technique that reduces overall manufacturing costs and decreases product defect potential, resin infusion between double flexible tooling has been invented and is the subject of the U.S. patent application Ser. No. 11,789,805, which is commonly owned with the instant application and is incorporated herein by reference in its entirety. Briefly, the resin infusion between double flexible tooling system is comprised of a housing that has an upper flexible diaphragm and a lower flexible diaphragm with the two diaphragms capable of forming a sealed cavity. A fiber reinforcement mat is positioned within the cavity while an appropriately shaped mold is positioned below the lower diaphragm and is capable of being pressed into the lower diaphragm. A flow plate that has a series of grooves therein, may be positioned either underneath the lower diaphragm or overtop the upper diaphragm such that the grooves, which are generally V-shaped and may have variable depths, press into the respective diaphragm, the grooves of the flow plate creating resin flow turbulence during infusion. A vacuum is created within the housing causing resin to be drawn into the cavity via an inlet gate. Once the mat is properly wetted, the mold is pressed into the lower diaphragm and the wetted mat is vacuum formed over the mold which may be made from a porous material in order to allow for increased intricacy in shape of end component.

This system creates a closed infusion mold system for creating polymer composite materials in an environmentally benign manner, which system is cost-effective over previous methods.

However, once a component is produced using the method, the component must undergo a series of finishing processes to prepare the substrate for painting. Not only are many of the painting methodologies currently employed laborious, time-consuming and expensive, they also tend to result in the release of volatile organic compounds (VOC) that are environmentally harmful.

In order to improve the finishing processes for composite components and reduce or eliminate the release of VOCs. in-mold coating processes of the composite components have been developed. In-mold coating for thermoplastic applications is the process by which an injection or compression molded part is decorated during the molding cycle. These processes, which require post trimming, eliminate the secondary coating operations while being able to achieve the same Class A finish as is possible with conventional painting. In-mold coating processes reduce the overall costs of the process while reducing the use of solvents in the finishing process. In-mold coating of composite components has been successfully used for many years for exterior body panels for vehicles made from compression molded Sheet Molding Compound (SMC) method. When injected onto a cured SMC part, the in-mold coating cures and bonds to provide a paint-like surface on the component so produced.

### SUMMARY OF THE INVENTION

The in-mold decoration of composites manufactured by resin infusion between double flexible tooling system of the present invention provides a system that allows for in-mold decoration of a composite part that is manufactured via the closed mold, resin infusion between double flexible tooling system. Class A finishes can be placed onto the part so manufactured without the need for costly and time consuming post-mold finishing processes. This not only reduces overall manufacturing costs and increases manufacturing throughput, but dramatically reduces the release of solvents into the environment.

The in-mold decoration of composites manufactured by resin infusion between double flexible tooling system of the present invention is comprised of a housing that has an upper flexible diaphragm and a lower flexible diaphragm such that the upper diaphragm and the lower diaphragm are drawn together into sealing relationship in order to create a cavity therebetween. The lower diaphragm has an inlet port and an outlet port. A fiber reinforcement mat is positioned within the cavity. A mold of desired shape is located within the housing and is positioned below the lower diaphragm and is capable of being pressed into the lower diaphragm. A first vacuum is created within the cavity via the outlet port so that a resin is drawn into the cavity in order to wet the mat, thereafter, a second vacuum is created within the housing, and thereafter the mold is pressed into the lower diaphragm. A first inner surface of the upper diaphragm is coated with a nonstick material and a second inner surface of the lower diaphragm is coated with the nonstick material. The lower diaphragm, the inlet port, and the outlet port are all located on a single plane. The mold may be made from a porous material. An optional flow plate that has a series of grooves may be provided and be positioned either underneath the lower diaphragm or overtop the upper diaphragm such that the grooves press into either the lower diaphragm or the upper diaphragm respectively, such that the resin that is drawn into the cavity interacts with the grooves thereby causing turbulence within the resin that is flowing within the cavity. The flow plate is removed prior to pressing the mold into the lower diaphragm if the flow plate is located between the mold and the lower diaphragm. The grooves are generally V-shaped and have variable depths. Means are provided for creating convective heating within the housing after the resin wets the mat, such means being a heating element and a blower. A paint film may be positioned on a first surface, a second surface, or both surfaces of the mat.

### BRIEF DESCRIPTION OF THE DRAWINGS

FIG. 1 is a top plan view of the in-mold decoration of composites manufactured by resin infusion between double flexible tooling system of the present invention.

FIG. 2 is a detail view of the upper frame member mated with the lower frame member forming the resin chamber, proximate the inlet port.

FIG. 3 is a section view of the in-mold decoration of composites manufactured by resin infusion between double flexible tooling system loaded for infusion.

FIG. 4 is a partially exploded view of the in-mold decoration of composites manufactured by resin infusion between double flexible tooling system.

FIG. 5 is a section view of the in-mold decoration of composites manufactured by resin infusion between double flexible tooling system with ultraviolet curing occurring during the manufacturing cycle.

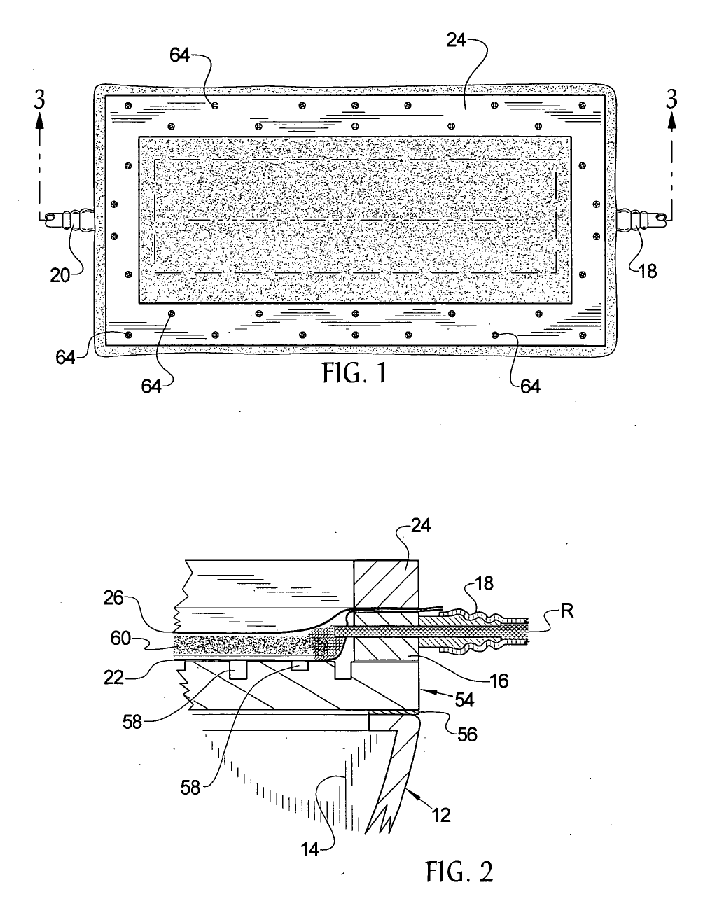

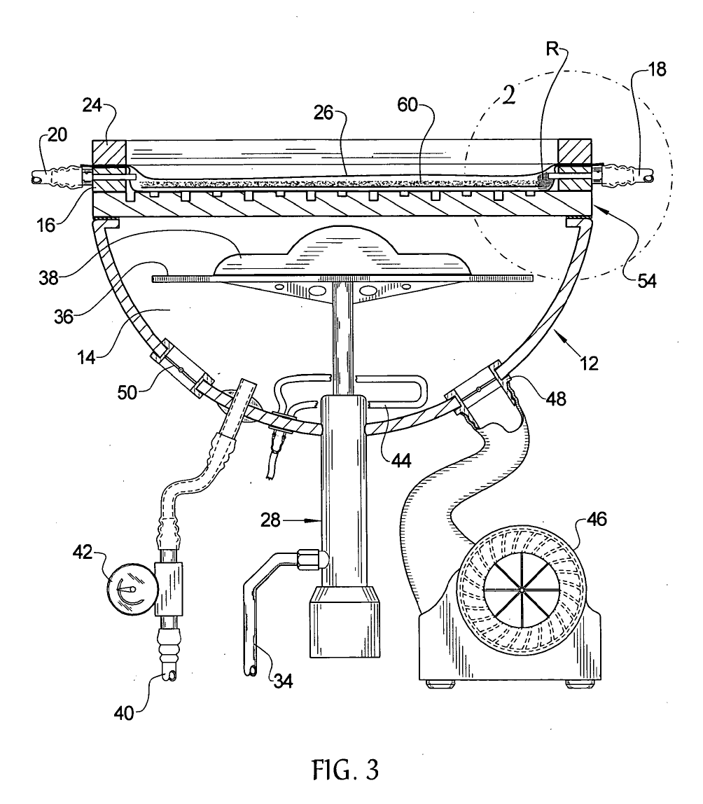

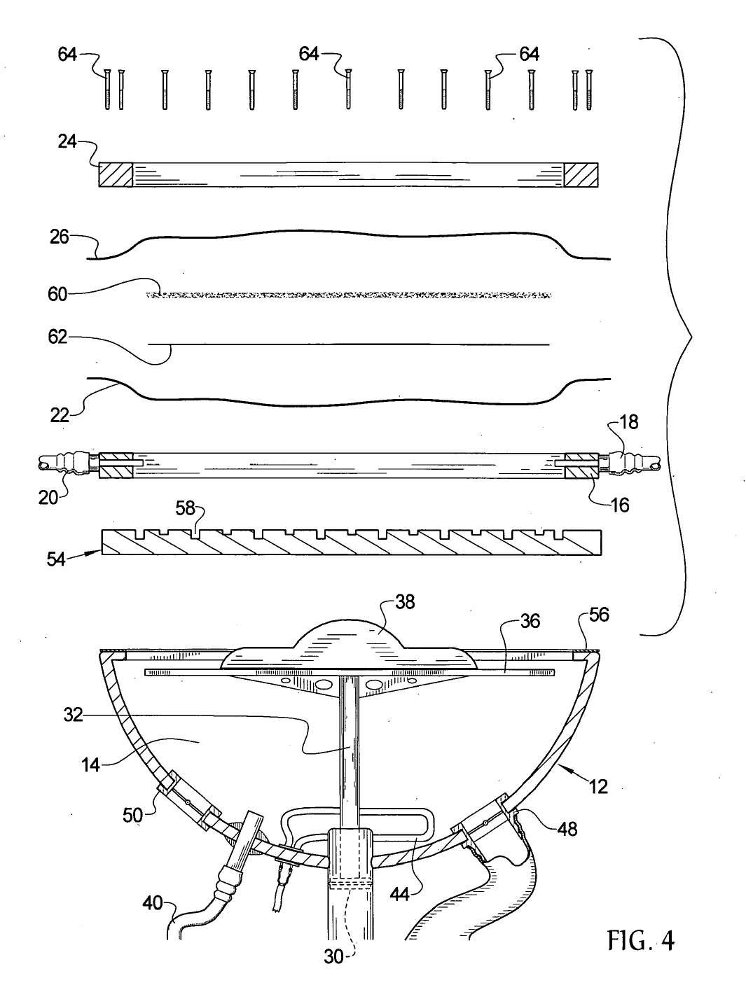

Similar reference numerals refer to similar parts throughout the several views of the drawings.

### DESCRIPTION OF THE PREFERRED EMBODIMENT

Referring now to the drawings, it is seen that the in-mold decoration of composites manufactured by resin infusion between double flexible tooling system of the present invention, generally denoted by reference numeral 10, comprises a housing 12 which has an interior chamber 14. A mold chamber comprises a lower frame member 16 that has an infusion or inlet port 18 and a vacuum or outlet port 20 on opposite sides of the lower frame member 16. The inlet port 18 and the outlet port 20 each lie on the same plane as that of the lower frame member 16. An appropriate lower diaphragm 22 lies across the opening of the lower frame member 16. A corresponding upper frame member 24 has a shape that is similar to that of the lower frame member 16 and has an upper diaphragm 26 spanning its opening. The lower diaphragm 22 and the upper diaphragm 26 are each made from an appropriate material that is sufficiently elastic, such as silicone rubber, the greater the elasticity of the diaphragms 22 and 26, the more intricacy can be introduced into the part to be manufactured by the in-mold decoration of composites manufactured by resin infusion between double flexible tooling system 10. If desired, the surfaces of the lower diaphragm 22 and the upper diaphragm 26 that come in contact with the flowing resin R, discussed below, may be coated with an appropriate nonstick material, such as TPFT, etc., in order to reduce the surface tension of the resin R that flows between the two diaphragms 22 and 26 during device 10 operation. Reduced surface tension of the resin R helps increase the overall surface quality of the product being manufactured.

A lifting mechanism 28, which may be the illustrated pneumatic piston 30 with a ram 32, connected to a source of pneumatic pressure via an appropriate connection line 34, is disposed within the housing 12 and has a plate 36 on the distal end of the ram 32. A mold 38, in the desired shape of the part to be manufactured is placed atop the plate 36. A vacuum line 40 is connected to an appropriate vacuum source (not illustrated) and has an appropriate gauge 42 thereon to monitor the vacuum operation. A resistive heating element 44 (or other appropriate form of heat generation) is disposed within the housing 12 while a blower 46 is also connected to the housing 12 via an appropriate valve 48 that is appropriately sealed. A vent 50 is located on the housing 12.

An ultraviolet curing (UV) lamp 52 is positioned overtop the two frame members 16 and 24.

An optional flow plate 54 may be positioned below the lower frame 16 and sits atop the housing 12 The flow plate 54 is made from a relatively stiff material, such as metal, hard plastic, etc., and has a series of V-shaped grooves 58 machined therein, the grooves 58 having varying depths.

The lower frame member 16 is appropriately sealed to the housing 12 via sealing gasket 56 in order to allow a vacuum to be maintained within the housing.

In order to use the in-mold decoration of composites manufactured by resin infusion between double flexible tooling system 10 of the present invention, a mold 38 in the desired shape of the finished product is selected and placed into the interior chamber 14 of the housing 12 atop the mold plate 36. A fiber reinforcement mat 60 is precut to fit the desired shape of the product to be formed and is placed onto the lower diaphragm 22 of the lower frame member 16 directly overhead of the mold 38. Thereafter, a decorative paint film 62 is carefully placed onto the reinforcement mat 60 (or, as illustrated, vice versa in the case that the inner surface of the component being formed is to be finished, or a paint film 62 is placed on both sides of the reinforcement mat 60 if both surfaces of the component being formed receive a paint finish). The decorative paint film 62 is a high-performance thermoplastic (thermo-formable) film that is compatible with a thermoset resin. We have used General Electric LEXAN films, which are polycarbonate films, and have found them quite satisfactory when tested with HETRON 922L, a low viscosity epoxy-based vinyl ester resin having Cobalt in the amount of about 0.3 percent of the total weight of the resin as a curing promoter. The upper frame member 24 is brought down into sealing engagement with the lower frame member 16 such that the reinforcement mat 60 and the paint film 62 are sandwiched between the upper diaphragm 26 and the lower diaphragm 22 in a resin chamber that is created between the two frame members 16 and 24. The upper frame member 24 is secured to the lower frame member 16 in any appropriate fashion such as by using the illustrated screws 64, latches, hydraulic pressure, etc. The diaphragms 22 and 26 may be dimensioned to so as to create the seal between the lower frame member 16 and the upper frame member 24 in order to create an airtight resin chamber or a separate sealing gasket (not illustrated) may be used.

The inlet port 18 is connected to a source of resin (not illustrated) by an appropriate inlet conduit (not illustrated). A vacuum is pulled into the resin chamber via the outlet port 20 in any appropriate fashion known in the art in order to draw resin R, typically a low viscosity resin, into the resin chamber in order to wet the reinforcement mat 60 being held therein. Both the inlet port 18 and the outlet port 20 lie on the same plane as that of the lower frame member 16 so that a true two-dimensional flow is achieved (as opposed to a 2.5-dimensional flow that is created when the two ports lie on different planes) which greatly improves resin R flow through the resin chamber allowing a continuous resin R flow through the resin chamber and helps avoid dry spots on the reinforcement mat 60. A simple resin trap (not illustrated) is positioned downstream of the outlet port 20 in order to catch any excess resin R and prevents the resin R from causing damage to the vacuum creating mechanism.

Once the resin R is properly infused, the ambient temperature within the resin chamber is increased via the heating element 44 and the blower 46. The use of the blower 46 helps keep the overall system 10 in thermal equilibrium. Once the temperature of the system 10 reaches a point wherein the paint film 62 becomes soft and formable (at least about 140 degrees Celsius for the GE LEXAN film, although different films 62 may have different thermal operating ranges—the resin curing trigger temperature must be above the paint film 62 forming temperature in order to prevent premature gelling of the resin R), the ram 32 of the lifting mechanism 28 raises the mold 38 into the lower diaphragm 22 of the lower frame member 16 (of course instead of using a lifting mechanism 28, the entire resin chamber can be lowered onto an otherwise stationary mold 38 in any appropriate fashion) and a vacuum is created within the interior chamber 14 of the housing 12. This vacuum draws the wetted reinforcement mat 60 and paint film 62 within the resin chamber into pressing engagement with the mold 38 in order for the wetted reinforcement mat 60 to take on the shape of the mold 38 with the thermo-formable paint film 62 permanently bonding to the desired surface of the finished component. The mold 38 may be made from a porous material so that the diaphragms 22 and 26 and the reinforcement mat 60 sandwiched therebetween can be pulled into any valleys or crevices found on the mold 38. Once the resin R and paint film 62 are properly cured and cooled, the lower frame 16 is detached from the upper frame 24 and the finished product is removed.

If the flow plate 54 is used and is located between the lower frame member 16 and the mold 38, the flow plate 54 is removed after the resin R has infused the reinforcement mat 60 and before the mold 38 is pressed into the lower diaphragm 22, the flow plate having served is purpose of creating turbulence within the flowing resin R within the resin chamber during reinforcement mat 60 wetting.

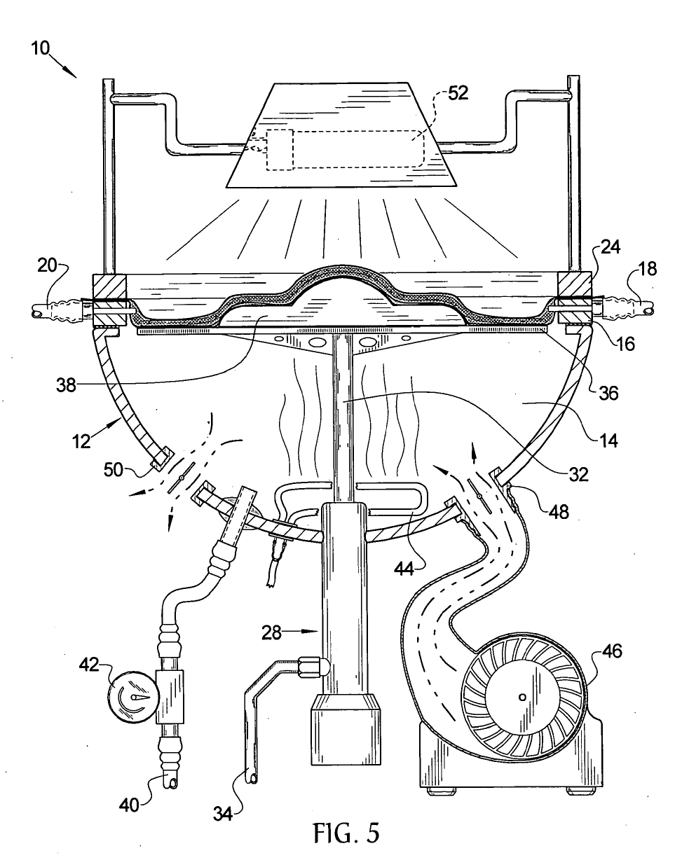

If desired the UV lamp 52 can be used as a cure on demand system by applying ultraviolet light via the UV lamp 52 onto the reinforcement side of the component (in the example illustrated in FIG. 5, the paint film 62 would be located on the top of the reinforcement mat 60 (between the mat 60 and the UV lamp 52) for proper UV curing after molding) once forming of the thermo-formable material 62 is complete. Exposure time has been measured on the order of about 90 seconds, however, this can be adjusted based on the particular parameters of the system utilizing the UV lamp 52

While the invention has been particularly shown and described with reference to an embodiment thereof, it will be appreciated by those skilled in the art that various changes in form and detail may be made without departing from the spirit and scope of the invention.

1-20. (canceled)

21. A method of resin infusion, comprising:
providing a housing having an upper flexible diaphragm and a lower flexible diaphragm, the upper diaphragm, the lower diaphragm capable of forming a cavity, the lower diaphragm having an inlet port and an outlet port;
positioning a fiber reinforcement mat positioned within the cavity;
providing a paint film and positioning the paint film on at least one side of the fiber reinforcement mat within the cavity;
providing a mold and positioning the mold below the lower diaphragm;
creating a vacuum within the cavity causing resin to be drawn into the cavity through the inlet port in order to cover the fiber reinforcement mat; and
pressing the mold and the lower diaphragm together.

22. The method of claim 21, wherein the vacuum is a first vacuum, and further comprising:
creating a second vacuum in a space between the mold and the lower diaphragm to cause the mold and the lower diaphragm to be pressed together.

23. The method of claim 21, wherein the paint film is a thermoplastic film.

24. The method of claim 21, wherein the paint film is a thermo-formable film.

25. The method of claim 21, wherein the resin drawn into the cavity is a thermoset resin and wherein the paint film is compatible with the thermoset resin.

26. The method of claim 21, wherein the paint film is a polycarbonate film.

27. The method of claim 21, wherein the resin drawn into the cavity is an epoxy-based vinyl ester resin.

28. The method of claim 21, wherein positioning the paint film on at least one side of the fiber reinforcement mat comprises positioning the paint film between the lower diaphragm and the fiber reinforcement mat.

29. The method of claim 21, wherein positioning the paint film on at least one side of the fiber reinforcement mat comprises positioning the paint film between the upper diaphragm and the fiber reinforcement mat.

30. The method of claim 21, wherein positioning the paint film on at least one side of the fiber reinforcement mat comprises positioning a first paint film between the fiber reinforcement mat and the upper diaphragm and positioning a second paint film between the fiber reinforcement mat and the lower diaphragm.

31. The method of claim 21, further comprising, prior to pressing the mold and the lower diaphragm together, heating the paint film.

32. The method of claim 31, wherein the paint film is heated to a first temperature, and wherein the resin has a curing temperature at or above a second temperature greater than the first temperature.

33. The method of claim 31, wherein heating the paint film is performed upon the resin substantially wetting the reinforcement mat.

34. The method of claim 21, further comprising, upon pressing the mold and the lower diaphragm together, applying ultraviolet light energy to the paint film and the fiber reinforcement mat to cure the paint film and the resin.

35. The method of claim 21, further comprising, upon curing the paint film and the resin, separating the upper diaphragm from the lower diaphragm to remove the resin infused fiber reinforcement mat.

36. The method of claim 21, wherein one of (a) the lower diaphragm or (b) the upper diaphragm, and the inlet port and the outlet port are all located on substantially a same plane.

37. The method of claim 21, further comprising providing a flow plate having a series of grooves therein, wherein the flow plate is positioned external to the cavity, either underneath the lower diaphragm or overtop the upper diaphragm such that the grooves press into either the lower diaphragm or the upper diaphragm.

38. The method of claim 37, further comprising removing the flow plate prior to pressing the mold and the lower diaphragm together.

39. The method of claim 37, wherein the grooves are generally V-shaped.

40. The method of claim 37, wherein the grooves have variable depths.
